(19) United States
(12) Patent Application Publication
(10) Pub. No.: US 2007/0111102 A1
(43) Pub. Date: May 17, 2007

(54) Negative electrode for non-aqueous electrolyte secondary batteries, non-aqueous electrolyte secondary battery having the electrode, and method for producing negative electrode for non-aqueous electrolyte secondary batteries

(76) Inventors: Kaoru Inoue, Osaka (JP); Masato Fujikawa, Osaka (JP); Takayuki Shirane, Osaka (JP); Hiroaki Matsuda, Osaka (JP); Sumihito Ishida, Osaka (JP)

Correspondence Address: MCDERMOTT WILL & EMERY LLP, 600 13TH STREET, N.W., WASHINGTON, DC, 20005-3096, US

(21) Appl. No.: 11/529,299

(22) Filed: Sep. 29, 2006

(30) Foreign Application Priority Data
Nov. 14, 2005 (JP) 2005-328387

(51) Int. Cl. H01M 4/62; H01M 4/58; B05D 5/12

(52) U.S. Cl. 429/232; 429/231.95; 427/122

(57) ABSTRACT

A negative electrode for non-aqueous electrolyte secondary batteries has a mixture layer including a composite negative electrode active material which is composed of active material cores capable of charging and discharging at least lithium ions; carbon nanofibers; and catalyst elements. The carbon nanofibers are attached to the surfaces of the active material cores. The catalyst elements are at least one selected from the group consisting of copper, iron, cobalt, nickel, molybdenum, and manganese, and promote the growth of the carbon nanofibers. The active material cores have the carbon nanofibers therebetween.

### BACKGROUND OF THE INVENTION

1. Field of the Invention

The present invention relates to a negative electrode for non-aqueous electrolyte secondary batteries which contains a composite negative electrode active material. The invention more particularly relates to a technique for providing a high-capacity negative electrode without sacrificing battery characteristics.

2. Background Art

With the advancement of portable and cordless electronic instruments, growing expectation has been directed to non-aqueous electrolyte secondary batteries smaller in size, lighter in weight, and higher in energy density. In non-aqueous electrolyte secondary batteries, carbon materials such as graphite are used as a negative electrode active material in practical applications. However, carbon materials have a theoretical capacity density of as low as 372 mAh/g. In order to increase the energy density of non-aqueous electrolyte secondary batteries, an attempt has been made where as the negative electrode active material are used silicon (Si), tin (Sn), germanium (Ge), an oxide thereof, and an alloy thereof which can form alloys with lithium. These materials have a higher theoretical capacity density than carbon materials. In particular, particles formed of active material cores such as silicon particles and silicon oxide particles have been widely studied because they are less expensive.

However, when these materials are used as a negative electrode active material and are subjected to repeated charging and discharging, the particles of the negative electrode active material change their volume with the number of charge-discharge cycles. This change in volume causes the active material particles to be collapsed into fine particles, thereby lowering conductivity among the particles. As a result, satisfactory charge-discharge cycle characteristics (hereinafter, cycle characteristics) are not attained.

To solve this problem, it has been proposed that the active material particles containing a metal or a semimetal that can form alloys with lithium are used as the cores and are bound to carbon fibers so as to be formed into composite particles. It has been reported that this structure can ensure the conductivity even if the active material particles change in volume, thereby maintaining sufficient cycle characteristics. One such technique is disclosed in Japanese Patent Application Laid-Open No.2004-349056.

Electrodes for non-aqueous electrolyte secondary batteries are generally produced as follows: a paste of an active material-containing mixture is applied on a metallic foil which works as a current collector, and dried; then, the resulting layer was rolled to attain higher density and desired thickness. Negative electrodes containing as an active material a carbon material such as graphite are also produced in a similar manner. A battery having a negative electrode produced in this manner performs smooth changing and discharging operations and exhibits excellent cycle characteristics. However, a battery having a negative electrode which is made from the aforementioned composite negative electrode active material and is rolled to achieve higher density provides greatly deteriorated cycle characteristics, probably due to the following mechanism. When rolled with an excessive load, the composite negative electrode active material particles are collapsed and generate new active material cores that have no carbon fibers attached to their surfaces. When a large number of such active material cores are generated, this means that active material cores separated from the conductive network of the negative electrode are born therein in a greater amount. These active material cores increase their influence over repeated charge-discharge cycles, thereby causing a deterioration in cycle characteristics.

### SUMMARY OF THE INVENTION

The present invention is directed to provide a negative electrode for non-aqueous electrolyte secondary batteries which enables a battery to exhibit excellent cycle characteristics by preventing the collapse of the conductive network and thereby avoiding an increase in the impedance of the negative electrode as a whole. The present invention is directed also to provide a non-aqueous electrolyte secondary battery having the negative electrode. The negative electrode of the present invention has a mixture layer containing a composite negative electrode active material which is composed of particles formed of active material cores capable of charging and discharging at least lithium ions, carbon nanofibers (hereinafter, CNFs), and catalyst elements. The CNFs are attached to the surfaces of the particles formed of the active material cores. The catalyst elements are at least one selected from the group consisting of copper (Cu), iron (Fe), cobalt (Co), nickel (Ni), molybdenum (Mo) and manganese (Mn), and promote the growth of the CNFs. The active material cores have CNFs therebetween. In a negative electrode with this structure, the presence of the CNFs between the particles formed of the active material cores ensures the conductive network.

### BRIEF DESCRIPTION OF THE DRAWINGS

FIG. 1A is a transparent plan view showing a structure of a model cell of an embodiment of the present invention.

FIG. 1B is a sectional view of the model cell shown in FIG. 1A taken along line 1B-1B.

FIGS. 2A to 2C are schematic diagrams showing changes in composite negative electrode active material particles contained in a negative electrode for non-aqueous electrolyte secondary batteries of the embodiment of the present invention when the composite negative electrode active material is rolled.

FIGS. 3A to 3C are schematic diagrams showing changes in composite negative electrode active material particles different from the particles used in the embodiment of the present invention when the composite negative electrode active material is rolled.

### DETAILED DESCRIPTION OF THE INVENTION

An embodiment of the present invention will be described as follows with reference to drawings. Note that the present invention is not limited to the following description except for its fundamental features.

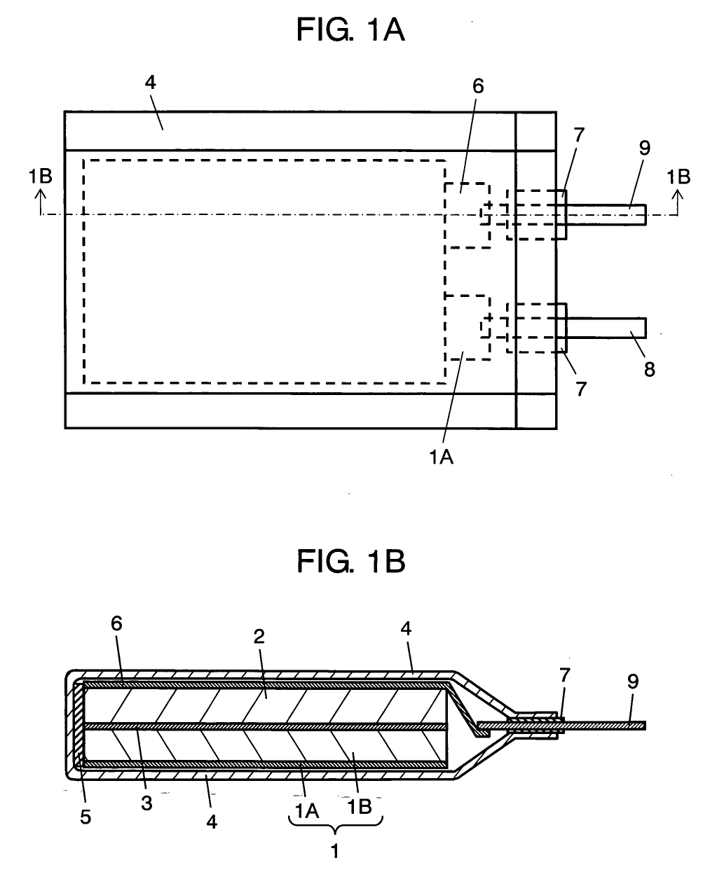

FIG. 1A is a transparent plan view showing the structure of a model cell produced to evaluate a negative electrode for non-aqueous electrolyte secondary batteries of the embodiment of the present invention. FIG. 1B is a cross sectional view taken along line 1B-1B.

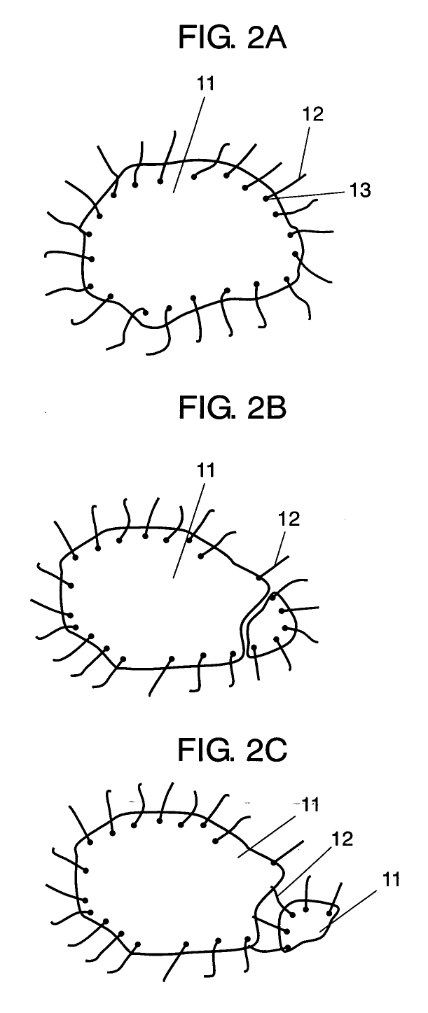

Negative electrode 1 shown in FIGS. 1A and 1B has current collector 1A and mixture layer 1B formed thereon. As shown in FIG. 2A, mixture layer 1B contains a composite negative electrode active material which is composed of active material cores 11 (hereinafter, cores 11) which can charge and discharge at least lithium ions, and carbon nanofibers 12 (hereinafter, CNFs 12) attached to the surfaces of cores 11. CNFs 12 are grown using catalyst elements 13 as nuclei which are supported on the surfaces of cores 11. Catalyst elements 13 are at least one selected from the group consisting of Cu, Fe, Co, Ni, Mo, and Mn, and promote the growth of CNFs 12. The volume proportion occupied by cores 11 in mixture layer 1B is 19% or more and 44% or less, and cores 11 have CNFs 12 therebetween.

Counter electrode 2 made of metallic lithium is faced to negative electrode 1 via separator 3 and is bonded to current collector 6 on the side opposite to separator 3. These components are housed in laminate bag 4 made by laminating a hot-melt resin film such as polyethylene to at least one side of a metal foil such as an aluminum foil. Laminate bag 4 is then filled with non-aqueous electrolyte 5 (hereinafter, electrolyte 5). Current collectors 1A and 6 are connected respectively with leads 8 and 9 exposed outside. Leads 8 and 9 are fixed by heating and melting modified polypropylene films 7 placed at the opening of laminate bag 4, so that laminate bag 4 is sealed.

The following is a detailed description of the composite negative electrode active material. Cores 11 are characterized by having a larger volume in a charged condition than in a discharged condition, and having a larger theoretical capacity density than carbon materials. The ratio of the volume A of cores 11 in a charged condition to the volume B in a discharged condition (A/B) is generally 1.2 or more. The theoretical capacity density of cores 11 is 833 mAh/cm³ or more. The composite negative electrode active material which contains cores 11 having such properties can maintain the original high-capacity characteristics regardless of the repeated expansion and contraction during charge-discharge cycles. This allows a secondary battery to achieve a practical level of cycle characteristics.

Cores 11 can be made of Si or SiOx where 0.05<x<1.95, or can be an alloy, a compound, a solid solution or the like in which Si is partly replaced with one or more elements selected from B, Mg, Ni, Ti, Mo, Co, Ca, Cr, Cu, Fe, Mn, Nb, Ta, V, W, Zn, C, N, and Sn. These elements can compose cores 11 either on their own or in combination. Examples of composing cores 11 in combination include a composite of a Si—O compound and a Si—N compound, and a composite of a plurality of compounds which contain silicon and oxygen in different ratios. Thus, cores 11 contain at least one selected from the group consisting of pure silicon, a silicon-containing alloy, a silicon-containing compound, and a silicon-containing solid solution. Of these, SiOx where 0.05<x<1.95 is desirable because of its comparative inexpensiveness and high stability.

CNFs 12 attach to the surfaces of cores 11 where they start to grow. In other words, CNFs 12 attach directly to the surfaces of cores 11 without adhesive resin therebetween. In some growing conditions, CNFs 12 may be chemically bonded to the surfaces of cores 11 at least at one end thereof which is the starting point of the growth. This reduces the resistance for current collection and assures high electronic conductivity in the battery, thereby providing excellent charge-discharge characteristics. In a case where CNFs 12 attach to cores 11 with catalyst elements 13, CNFs 12 are not easily detached from cores 11, making negative electrode 1 more resistant to mechanical load (hereinafter, called as rolling load) which is applied to negative electrode 1 when it is rolled to attain a higher density.

In order to allow catalyst elements 13 to exhibit excellent catalytic activity until CNFs 12 are fully grown, catalyst elements 13 are preferably present in a metallic state in the surface parts of cores 11. More specifically, catalyst elements 13 are preferably present in the form of metal particles having a diameter of, for example, 1 nm to 1000 nm. On the other hand, when the growth of CNFs 12 is complete, the metal particles of catalyst elements 13 are preferably oxidized.

CNFs 12 have a fiber length of preferably 1 nm to 1 mm, and more preferably 500 nm to 100 μm. When the fiber length is less than 1 nm, the effect to increase electrode conductivity is too small. In contrast, the fiber lengths of over 1 mm tend to reduce the active material density or capacity of the electrode. Although not limited, CNFs 12 are preferably in the form of at least one selected from the group consisting of a tube shape, an accordion shape, a plate shape, and a herringbone shape. CNFs 12 may absorb catalyst elements 13 during their growth. CNFs 12 have a fiber diameter of preferably 1 nm to 1000 nm, and more preferably 50 nm to 300 nm.

Catalyst elements 13 in a metallic state work as active sites to grow CNFs 12. More specifically, CNFs 12 start to grow when cores 11 with catalyst elements 13 exposed in a metallic state on their surfaces are introduced into a high-temperature atmosphere containing the source gas of CNFs 12. When cores 11 have no catalyst elements 13 on their surfaces, CNFs 12 do not grow.

Methods for providing metal particles of catalyst elements 13 on the surfaces of cores 11 are not particularly limited; however, one preferable method is to support metal particles on the surfaces of particles that can charge and discharge lithium ions.

When the metal particles are supported in this manner, it is possible to mix cores 11 with the metal particles in solid form; however, it is preferable to soak cores 11 in a solution of a metal compound which is the source material of the metal particles. After soaking, the solvent is removed from cores 11, which can be heated if necessary, to obtain cores 11 which support on their surfaces catalyst elements 13 in the form of metal particles having a diameter of 1 nm to 1000 nm and preferably 10 nm to 100 nm in a highly and uniformly dispersed state.

It is difficult to form the metal particles of catalyst elements 13 having a diameter of less than 1 nm. On the other hand, when formed to have a diameter of over 1000 nm, the metal particles of catalyst elements 13 may be extremely uneven in size, making CNFs 12 difficult to grow, or making it difficult to form a highly conductive electrode. Therefore, the diameter of the metal particles of catalyst elements 13 is preferably 1 nm or more and 1000 nm or less.

Specific examples of the metal compound to obtain the aforementioned solution include nickel nitrate, cobalt nitrate, iron nitrate, copper nitrate, manganese nitrate, and hexaammonium heptamolybdate tetrahydrate. The solvent used for the solution can be selected from water, an organic solvent and a mixture of water and an organic solvent as appropriate according to the solubility of the compound and the compatibility of the compound with the electrochemical active phases contained in cores 11. Specific examples of the organic solvent include ethanol, isopropyl alcohol, toluene, benzene, hexane, and tetrahydrofuran.

Alternatively, it is also possible to synthesize alloy particles containing cores 11 and catalyst elements 13. This synthesis is performed by a common alloying method. The metallic materials of cores 11 such as silicon, elements react electrochemically with lithium to form alloys, thereby forming electrochemical active phases in cores 11. On the other hand, the metallic phases of catalyst elements 13 are at least partly exposed in the form of particles having a diameter of 10 nm to 100 nm on the surfaces of the alloy particles.

The metal particles or metallic phases of catalyst elements 13 are preferably 0.01 wt % to 10 wt % of cores 11, and more preferably 1 wt % to 3 wt %. When the content of the metal particles or the metallic phases is too low, it takes a lot of time to grow CNFs 12, thereby decreasing production efficiency. In contrast, when the content is too high, catalyst elements 13 agglomerate, causing CNFs 12 to grow unevenly and to have large fiber diameters. This leads to a decrease in the conductivity and active material density of mixture layer 1B. This also leads to a decrease in the proportion of the electrochemical active phases, making it difficult to use the composite negative electrode active material as a high-capacity electrode material.

The following is a description of a method for producing the composite negative electrode active material particles composed of cores 11, CNFs 12, and catalyst elements 13. This production method includes the following four steps of (a) to (d).

(a) A step of loading catalyst elements 13 at least in the surface parts of cores 11 which can charge and discharge lithium ions. Catalyst elements 13 are at least one selected from the group consisting of Cu, Fe, Co, Ni, Mo, and Mn which promotes the growth of CNFs 12.

(b) A step of growing CNFs 12 on the surfaces of cores 11 in an atmosphere containing carbon-containing gas and hydrogen gas.

(c) A step of sintering cores 11 with CNFs 12 attached thereto in an inert gas atmosphere at 400° C. or more and 1600° C. or less.

(d) A step of crushing cores 11 with CNFs 12 attached thereto so as to adjust the tap density of cores 11 to 0.42 g/cm³ or more and 0.91 g/cm³ or less.

After Step (c), the composite negative electrode active material particles can be subjected to heat treatment in the air at 100° C. or more and 400° C. or less so as to oxidize catalyst elements 13. The heat treatment at this temperature range can oxidize only catalyst elements 13 without oxidizing CNFs 12.

As Step (a), there may be mentioned a step of supporting the metal particles of catalyst elements 13 on the surfaces of cores 11; a step of reducing the surfaces of cores 11 containing catalyst elements 13; a step of synthesizing alloy particles of silicon and catalyst elements 13; and other steps.

The following is a description of conditions when CNFs 12 are grown on the surfaces of cores 11 at Step (b). CNFs 12 start to grow when cores 11 having catalyst elements 13 at least in the surface parts thereof are introduced into a high-temperature atmosphere containing the source gases of CNFs 12. For example, cores 11 are placed in a ceramic reaction vessel and heated to high temperatures of 100° C. to 1000° C., and more preferably to 300° C. to 600° C. in an inert gas or a gas having a reducing power. Then, carbon-containing gas and hydrogen gas, which are the source gases of CNFs 12, are introduced into the reaction vessel. When the temperature in the reaction vessel is less than 100° C., CNFs 12 either do not grow or grow very slowly, thereby damaging the productivity. In contrast, when the temperature in the reaction vessel exceeds 1000° C., the source gases are decomposed rapidly, making it harder to grow CNFs 12.

The source gases are preferably a mixture gas of carbon-containing gas and hydrogen gas. Specific examples of the carbon-containing gas include methane, ethane, ethylene, butane, and carbon monoxide. The molar ratio (volume ratio) of the carbon-containing gas in the mixture gas is preferably 20% to 80%. When catalyst elements 13 in a metallic state are not exposed on the surfaces of cores 11, the proportion of the hydrogen gas can be increased to perform the reduction of catalyst elements 13 and the growth of CNFs 12 in parallel. When the growth of CNFs 12 is terminated, the mixture gas of the carbon-containing gas and the hydrogen gas is replaced with an inert gas and the inside of the reaction vessel is cooled to room temperature.

Next, in Step (c), cores 11 having CNFs 12 attached thereto are sintered in an inert gas atmosphere at 400° C. or more and 1600° C. or less. This sintering is preferable because it can prevent the irreversible reaction between electrolyte 5 and CNFs 12 which progresses at the initial charge of the battery, thereby achieving excellent charge-discharge efficiency of the battery. When such sintering process is either not performed or performed at a temperature less than 400° C., the irreversible reaction may not be prevented, causing a decrease in the charge-discharge efficiency. In contrast, when sintering temperatures exceed 1600° C., the electrochemical active phases of cores 11 react with CNFs 12 and may be inactivated or reduced, so that the capacity may be decreased. For example, when the electrochemical active phases of cores 11 are made of silicon, the silicon reacts with CNFs 12 to generate inert silicon carbide, thereby causing a decrease in the charge-discharge capacity of the battery. When cores 11 are made of silicon, the sintering temperature is particularly preferably 1000° C. or more and 1600° C. or less. Some growth conditions could improve the crystallinity of CNFs 12. When CNFs 12 have high crystallinity, the irreversible reaction between electrolyte 5 and CNFs 12 can be prevented. In this case, Step (c) is not necessary.

After being sintered in the inert gas, the composite negative electrode active material particles are preferably heat-treated in the air at 100° C. or more and 400° C. or less in order to oxidize at least parts (surfaces, for example) of the metal particles or metallic phases of catalyst elements 13. When the heat-treatment temperature is less than 100° C., it is difficult to oxidize the metal, whereas temperatures exceeding 400° C. may burn CNFs 12 thus grown.

In Step (d), sintered cores 11 with CNFs 12 attached thereto are crushed. Crushing is preferred, because the particles of the composite negative electrode active material acquire good filling ability (compactability). However, when the tap density is 0.42 g/cm³ or more and 0.91 g/cm³ or less, crushing may not be necessary. In other words, when cores 11 with excellent compactability are used as a source material, crushing may not be necessary.

The following is a description of a method for producing negative electrode 1. The composite negative electrode active material composed of cores 11 with CNFs 12 attached to their surfaces is mixed with a binder and a solvent so as to prepare a mixture slurry. Combination examples of the binder and the solvent include polyvinylidene fluoride (PVDF) and N-methyl-2-pyrrolidone (NMP); and an emulsion of polytetrafluoroethylene and water. Other examples of the binder include polyethylene, polypropylene, an aramid resin, polyamide, polyimide, polyamideimide, polyacrylonitrile, polyacrylic acid, poly(methyl acrylate), poly(ethyl acrylate), polyhexylacrylate, poly(methacrylic acid), poly(methyl methacrylate), poly(ethyl methacrylate), poly(hexyl methacrylate), polyvinyl acetate, polyvinylpyrrrolidone, polyether, polyethersulfone, hexafluoropolypropylene, styrene-butadiene rubber, and carboxymethyl cellulose. Further other examples of the binder include copolymers containing at least two selected from tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene.

The obtained mixture slurry is applied on current collector 1A using a doctor blade and dried so as to form mixture layer 1B on current collector 1A. Mixture layer 1B is rolled to adjust its thickness and also to adjust the volume proportion occupied by cores 11 in mixture layer 1B to 19% or more and 44% or less. A long strip of negative electrodes thus obtained is either stamped or cut into a predetermined size. Lead 8 made of nickel or copper is, for example, welded to the exposed part of current collector 1A so as to complete negative electrode 1.

Current collector 1A can be a metal foil made of stainless steel, nickel, copper, or titanium, or a thin film made of carbon or a conductive resin. Current collector 1A can also be surface-treated with carbon, nickel, titanium, or the like.

It is also possible to add the following conductive agent to mixture layer 1B when necessary. Specific examples of the conductive agent include graphites such as expanded graphite, artificial graphite, and natural graphite such as scaly graphite; carbon blacks such as acetylene black, Ketjen black, channel black, furnace black, lamp black, and thermal black; conductive fibers such as carbon fiber and metal fiber; metal powders such as copper powder and nickel powder; and organic conductive materials such as a polyphenylene derivative.

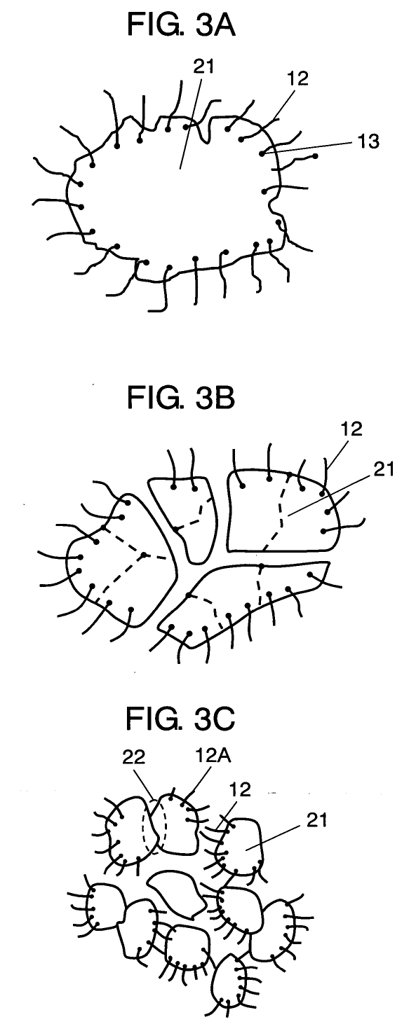

The following is a description of changes in the. composite negative electrode active material particles during the rolling of negative electrode 1 with reference to FIGS. 2A to 2C and FIGS. 3A to 3C. As shown in FIG. 2A, the composite negative electrode active material particles of the present embodiment have cores 11 and CNFs 12 attached to them. CNFs 12 are present at least between cores 11. The presence of highly conductive CNFs 12 between poorly conductive cores 11 allows cores 11 to maintain conductive network. Maintaining such an electrode structure can improve the electronic conductivity in mixture layer 1B, thereby improving cycle characteristics.

The form (properties) of the composite negative electrode active material particles affects the ease with which the aforementioned electrode structure is obtained. This ease closely relates to the compactability of the composite negative electrode active material particles. When the form of cores 11 is controlled enough to make the composite negative electrode active material particles highly compactable, as shown in FIG. 2B, there is small need to increase rolling load. Therefore, the cracking of the composite negative electrode active material particles can be reduced to some extent when a rolling load is applied. The composite negative electrode active material particles thus cracked are relocated at random in mixture layer 1B, and as a result, the structure where CNFs 12 are present between cores 11 is developed as shown in FIG. 2C.

On the other hand, in a situation that the composite negative electrode active material particles are hard to be compacted, CNFs 12 are unlikely to form conductive network. Cores 11 are generally not spherical, but are indefinite in shape. Composite negative electrode active material particles containing active material cores 21 (hereinafter, cores 21) which are very far from being spherical as shown in FIG. 3A are poorly compactable. Applying a rolling load to a negative electrode having such composite negative electrode active material particles in a mixture layer causes a lot of cracks in cores 21 as shown in FIG. 3B. The occurrence of cracks is affected by the shapes of cores 21 and the grain boundaries of the particles. Applying a large rolling load in an attempt to increase the packing density of the completed composite negative electrode active material particles with poor compactability would cause cracks.

Consequently, as shown in FIG. 3C, the cracked negative electrode active material particles randomly present on the mixture layer generate a lot of portions 22 having no CNFs 12 between cores 21. In other words, the proportion of CNFs 12A that are present somewhere other than between cores 21 increases. As a result, electronic conductivity and ionic conductivity in mixture layer 1B both decrease, thereby causing the battery to decrease both in cycle characteristics and high-load characteristics. Reducing rolling load causes a reduction in the packing density of cores 11, which are the main body of the active material to charge and discharge lithium ions. This reduces battery energy density.

The volume proportion occupied by cores 11 in mixture layer 1B should be in an appropriate range. More specifically, when there are a lot of CNFs 12 and the volume proportion occupied by cores 11 is less than 19%, conductive network is formed properly, but the capacity density becomes low because the packing density of cores 11 is low.

On the other hand, when the volume proportion occupied by cores 11 exceeds 44%, cores 11 are too compact to have enough space formed with CNFs 12. This makes the ion supply from electrolyte 5 to cores 11 insufficient and therefore the high-load characteristics are lowered. Furthermore, increasing rolling load to achieve this condition causes more damage to the composite negative electrode active material particles. This results in a reduction in electronic conductivity and also in a slight reduction in cycle characteristics.

When the volume proportion occupied by cores 11 in mixture layer 1B is 19% or more and 44% or less, the space formed with CNFs 12 serves as the path of electrolyte 5 so that the ion conductivity can be high. This allows electrolyte 5 to be supplied sufficiently to cores 11 so that the battery can have smooth charge-discharge reaction, thereby having excellent high-load characteristics. In addition, the conductive network formed among cores 11 is well developed enough to achieve excellent electronic conductivity, so that the battery cycle characteristics can be high. In conclusion, it is preferable that the volume proportion occupied by cores 11 in mixture layer 1B be 19% or more and 44% or less.

A large proportion of CNFs 12 tends to decrease the compactability of the composite negative electrode active material particles because CNFs 12 are bulky. In contrast, when the proportion of CNFs 12 is too small, conductive network is not well developed between composite negative electrode active material particles even when the volume proportion occupied by cores 11 is in an appropriate range. Therefore, the weight proportion of CNFs 12 in the composite negative electrode active material particles should be in an appropriate range. When the weight proportion is less than 6%, the electronic conductivity becomes lower than a required level, making the cycle characteristics slightly low. On the other hand, when the weight proportion is over 35%, the composite negative electrode active material particles become too bulky and are required to have higher rolling load, thereby causing more damage to the composite negative electrode active material particles. As a result, the weight proportion of CNFs 12 in the composite negative electrode active material particles is preferably 6% or more and 35% or less. Thus, the appropriate volume proportion occupied by cores 11 in mixture layer 1B and the appropriate weight proportion of CNFs 12 in the composite negative electrode active material particles achieve well-developed conductive network between the composite negative electrode active material particles.

One index to evaluate the compactability of the composite negative electrode active material particles is tap density. Tap density is determined in the following manner basically compliant with JIS-K5101. “Powder Tester” manufactured by Hosokawa Micron Corp. is used for the measurement; a sieve with an aperture of 710 μm is used, through which sample powders are passed. The sample powders are dropped in a tapping cell of 25 cc until the cell is full. Then, tapping one time per second with a stroke length of 18 mm is performed 600 times. The height and weight of the powder in the cell are measured to calculate the tap density.

When the tap density is less than 0.42 g/cm³, the poor compactability of the composite negative electrode active material particles requires large rolling load in order to ensure good battery energy density. This causes more damage to the composite negative electrode active material particles, thereby making cores 11 crack and fall apart, and decreasing the electronic conductivity. As a result, cycle characteristics decrease. In contrast, when the composite negative electrode active material particles are highly compactable, a necessary packing density can be obtained without the application of large rolling load. The damage to the composite negative electrode active material particles is reduced.

The tap density of the composite negative electrode active material particles increases as the particles are closer to spherical and are larger in diameter. Therefore, when the tap density is too large, the surface area of the particles is relatively small. The tap density exceeding 0.91 g/cm³ lowers the high-load characteristics because the surface area of cores 11 is too small. In conclusion, it is preferable to use composite negative electrode active material particles having a tap density of 0.42 g/cm³ or more and 0.91 g/cm³ or less.

In order to put CNFs 12 between cores 11, cores 11 having an appropriate tap density can be crushed after being coated with CNFs 12. In this approach, the crushing of cores 11 and the measuring of the tap density can be repeated alternately to obtain appropriate composite negative electrode active material particles.

As described above, cores 11 are not perfect spheres and may have indefinite shapes, so that when the average particle diameter is less than 1 μm, the obtained composite negative electrode active material particles tend to be poorly compactable. This requires increasing the rolling load and thus causes more damage to the composite negative electrode active material particles. Consequently, the electronic conductivity decreases, and the cycle characteristics is slightly lowered. When the average particle diameter is less than 1 μm, cores 11 are likely to form strong aggregates. Such aggregates have unexposed portions where CNFs 12 do not grow. As a result, cores 11 come into direct contact with each other in many portions.

In contrast, when the average particle diameter exceeds 14 μm, the surface area of cores 11 is relatively small, and the high-load characteristics are slightly lowered. Furthermore, unless the amount of CNFs 12 is reduced, the volume proportion occupied by cores 11 is more likely to exceed 44%, which is the upper limit of the acceptable range. In conclusion, the average particle diameter of cores 11 is preferably 1 μm or more and 14 μm or less.

The following is a description of advantages of the present invention with specific experiments and the results. First, the volume proportion occupied by cores 11 in mixture layer 1B, and the average particle diameter of cores 11 are studied as follows, using test cells 1 to 12.

Preparation of Test Cells

Test cell 1 is prepared as follows. Firstly, silicon monoxide (SiO) particles which serve as cores 11 are pulverized and classified to have an average particle diameter of 0.5 μm. One part by weight of nickel nitrate (II) hexahydrate is dissolved in ion exchange water to prepare a solution which is used for preparing catalyst elements. To this solution are added SiO particles. The solution is stirred for one hour, and then, water is removed therefrom using an evaporator so as to load nickel nitrate on the surfaces of the SiO particles.

Next, the SiO particles with nickel nitrate supported thereon are placed in a ceramic reaction vessel and heated to 550° C. in the presence of helium gas. Then, the helium gas is replaced by a mixture gas consisting of hydrogen gas and methane gas in a volume ratio of 50:50, and left for ten minutes at 550° C. so as to reduce nickel nitrate (II) and to grow CNFs 12 on the SiO particles. After this, the mixture gas is replaced by helium gas, and the inside of the reaction vessel is cooled to room temperature. The temperature is then raised again to 1000° C. in argon gas, the SiO particles are sintered for one hour at 1000° C. so as to obtain a composite negative electrode active material. The weight proportion of CNFs 12 in the composite negative electrode active material particles is set to 15%. After that, the composite negative electrode active material particles are crushed. The obtained composite negative electrode active material particles have a tap density of 0.33 g/cm³.

The obtained composite negative electrode active material particles are observed with a scanning electron microscope (hereinafter, called as SEM); CNFs 12 are found to be attached to the surfaces of cores 11. The nickel nitrate supported on cores 11 are reduced to particles having a particle diameter of about 100 nm. The nickel particles are observed with SEM for their particle diameter, fiber diameter, and fiber length. The weight of CNFs 12 is determined by changes in weight before and after CNFs 12 are grown.

Then, 100 parts by weight of the composite negative electrode active material are mixed with 7 parts by weight (solid content) of an N-methyl-2-pyrrolidone (hereinafter, called as NMP) solution of PVDF as a binder and an appropriate amount of NMP so as to prepare a negative electrode mixture slurry. The resulting slurry is applied on current collector 1A made of a 15 μm—think Cu foil using a doctor blade, dried at 60° C. so as to make mixture layer 1B supported on current collector 1A. The volume proportion occupied by cores 11 in mixture layer 1B is 0.18% after the drying. Mixture layer 1B is stamped in a square having a width of 32 mm and a longitudinal length of 42 mm and is used as negative electrode 1.

Negative electrode 1 thus obtained is used together with counter electrode 2 and separator 3 so as to prepare a flat test cell. Counter electrode 2 is made of metallic lithium, which is 300 μm thick, 34 mm wide, and 44 mm long. Separator 3 is made of a polyethylene microporous membrane having a thickness of 20 μm and a porosity of about 40%. The test cell is then housed in laminate bag 4. Laminate bag 4 is sealed after being filled with electrolyte 5; electrolyte 5 is a solution containing a mixture solvent of ethylene carbonate and diethyl carbonate, and LiPF₆ dissolved at a concentration of 1 mol/dm³ in the mixture solvent.

Test cells 2 to 9 are prepared in the same manner as test cell 1 except that the pulverizing and classifying conditions of SiO particles are changed so that the average particle diameters of the SiO particles can be 1, 2, 4, 8, 10, 12, 14, and 18 μm, respectively.

Test cell 10 is prepared in the same manner as test cell 6 except that the sintered composite negative electrode active material particles are used without being crushed.

Test cells 11 and 12 are prepared in the same manner as test cell 6 except that mixture layer 1B is supported on current collector 1A, and then negative electrode 1 that has been dried but not been cut yet is rolled with a load of 300 kgf/cm and 1000 kgf/cm, respectively.

Evaluations of Test Cell Characteristics

The test cells use metallic lithium as counter electrode 2, so that negative electrode 1 has a higher charge-discharge potential than counter electrode 2. In the following description, charging operation and discharging operation respectively indicate the absorption and desorption of lithium ions to and from negative electrode 1. In other words, the voltages of the test cells are decreased by charging and increased by discharging.

Each test cell is measured for the initial charge and discharge capacities at a charge-discharge current of 0.1 CmA. The obtained discharge capacity is converted to the discharge capacity per apparent unit volume (1 cm³) of mixture layer 1B (apparent volume: simply calculated from the outside dimension of mixture layer 1B) so as to calculate a discharge capacity density. The charging is performed until the voltage between the electrodes reaches 0V and the discharging is performed until the voltage reaches 1.5V. In this case, 0.1 CmA indicates a current value obtained by dividing the designed capacity of batteries by ten hours.

The test cells are then evaluated for high-load characteristics as follows. Each test cell is charged with a current of 0.1 CmA and then discharged with a current of 1 CmA so as to measure the discharge capacity at 1 CmA. The obtained discharge capacity is divided by the discharge capacity of 0.1 CmA to determine the high-load capacity retention rate, which is used as an index of high-load characteristics.

In the end, each test cell is evaluated for cycle characteristics. Charge-discharge operations are repeated for 50 cycles under the same conditions as the initial capacity measurement. The ratio of the discharge capacity at the 50th cycle to the initial discharge capacity is divided by the number of cycles (50) to determine the degradation rate per cycle (cycle degradation rate), which is used as an index of the cycle characteristics.

By referring to the case where a negative electrode containing graphite active material is used, the evaluation standards of the discharge capacity density and the high-load capacity retention rate are set to 500 mAh/cm³ or more and 90% or more, respectively. The evaluation standard of the cycle degradation rate is set to 0.10% or less per cycle after practical usefulness is considered. The configuration of each test cell and the results of the aforementioned evaluations are shown in Table 1 below.

TABLE 1

| | | | | Negative electrode | | | | |
|---|---|---|---|---|---|---|---|---|
| | | | | | | Discharge | Highload | |
| | SiO | CNF | Composite negative | Rolling | volume | capacity | capacity | Cycle |
| Test | diameter | weight | electrode material | load | proportion | density | retention | degradation |
| cell | μm | proportion % | tap density g/cm³ | kgf/cm | of SiO Vol % | mAh/cm³ | rate % | rate %/cycle |
| 1 | 0.5 | 15 | 0.39 | — | 18 | 648 | 89 | 1.00 |
| 2 | 1 | 15 | 0.42 | — | 22 | 770 | 98 | 0.06 |
| 3 | 2 | 15 | 0.44 | — | 22 | 797 | 98 | 0.06 |
| 4 | 4 | 15 | 0.50 | — | 25 | 878 | 98 | 0.06 |
| 5 | 8 | 15 | 0.60 | — | 28 | 1013 | 98 | 0.06 |
| 6 | 10 | 15 | 0.63 | — | 30 | 1053 | 95 | 0.06 |
| 7 | 12 | 15 | 0.70 | — | 32 | 1148 | 94 | 0.06 |
| 8 | 14 | 15 | 0.73 | — | 33 | 1188 | 91 | 0.06 |
| 9 | 18 | 15 | 0.78 | — | 35 | 1256 | 88 | 0.06 |
| 10 | 10 | 15 | 0.42 | — | 22 | 770 | 95 | 0.06 |
| 11 | 10 | 15 | 0.63 | 300 | 44 | 1418 | 95 | 0.06 |
| 12 | 10 | 15 | 0.63 | 1000 | 46 | 1620 | 89 | 1.00 |

Comparison of test cells 1 to 9 indicates the following. In test cells 2 to 8 where the average particle diameters of SiO particles are between 1 μm and 14 μm inclusive, the volume proportions occupied by cores 11 are in the range of 22% or more and 33% or less, and the discharge capacity density, high-load characteristics, and cycle characteristics are all excellent. In test cell 1, on the other hand, the average particle diameter of the SiO particles is as small as 0.5 μm, so that the crushed composite negative electrode active material particles have a small tap density and are hard to be compacted. The volume proportion occupied by cores 11 is also as small as 18%, so that the conductive network is not developed sufficiently and that the high-load characteristics are slightly low. In addition, the SiO particles form strong aggregates, thereby having some portions where CNFs 12 are not present. Consequently, cycle characteristics are very low. In test cell 9, the SiO particles in the composite negative electrode active material have a large particle diameter, so that the SiO particles have a small surface area, making high-load characteristics slightly low. In conclusion, the average particle diameter of the SiO particles, which form cores 11, is preferably 1 μm or more and 14 μm or less. In terms of high-load characteristics, the average particle diameter is more preferably 1 μm or more and 12 μm or less, and further more preferably 1 μm or more and 10 μm or less.

The following is a comparison between test cells 10 to 12 and test cell 6. In the preparation of negative electrode 1, the sintered composite negative electrode active material particles are crushed in test cell 6, but are not crushed in test cell 10. The absence of crushing makes the composite negative electrode active material particles have a slightly small tap density and unlikely to be compacted. As a result, the volume proportion occupied by the SiO particles which are cores 11 in mixture layer 1B is as small as 22%, making the discharge capacity density small. The reason for this seems to be that the packing density of the SiO particles (or the composite negative electrode active material particles) is slightly low. Even so, test cell 10 is as excellent in quality as test cell 2. This is because the SiO particles which are a source material of the composite negative electrode active material and have an average particle diameter of 10 μm are highly compactable. Therefore, it is not essential to crush the composite negative electrode active material particles. Although the experimental results are not shown, when the SiO particles which are a source material are not so compactable and the volume proportion occupied by the SiO particles in mixture layer 1B is less than 19%, the capacity density, high-load characteristics, and cycle characteristics are all low.

While in test cell 6 is not performed a rolling operation in the preparation of negative electrode 1, in test cells 11 and 12 is performed the rolling operation at different loads from each other. The volume proportion occupied by cores 11 is 44% in cell 11, and 46% in cell 12. In test cell 11, the SiO particles are not cracked because the rolling load is not large, so that both high-load characteristics and cycle characteristics are as excellent as in test cell 6. In addition, the thickness is reduced by rolling, so that the discharge capacity density is increased as compared with test cell 6.

On the other hand, in test cell 12, the rolling operation is performed at a large load in an attempt to achieve higher capacity by increasing the volume proportion occupied by cores 11. As a result, the spaces between the SiO particles are not enough, and the high-load characteristics are lowered. Furthermore, it seems that the large rolling load causes the SiO particles to be in direct contact with each other in some portions, and that the SiO particles are cracked. As a result, cycle characteristics are lowered.

The following is a description of study on the optimum range of the weight proportion of CNFs 12 in the composite negative electrode active material particles. The weight proportion of CNF12 to SiO is changed by using as a source material SiO particles having average particle diameters of 1 μm, 8 μm, and 14 μm, respectively, and changing the reaction time.

First, the case of using as a source material SiO particles having an average particle diameter of 1 μm is described with reference to Table 2 below. Test cells 13 to 18 are prepared in the same manner as test cell 2 except that the weight proportions of CNFs 12 in the composite negative electrode active material particles are set to 5%, 6%, 10%, 20%, 30%, and 35%, respectively. In the following evaluation results including the evaluation results shown in Table 2, the discharge capacity density is calculated on the basis of the tap volume of the composite negative electrode active material particles. “Tap volume” stands for a volume of powder or particles in a state where the powder or particles are packed and compressed to determine the tap density.

TABLE 2

| | | | | Negative electrode | | | | |
|---|---|---|---|---|---|---|---|---|
| | | | | | | Discharge | Highload | |
| | SiO | CNF | Composite negative | Rolling | volume | capacity | capacity | Cycle |
| Test | diameter | weight | electrode material | load | proportion | density | retention | degradation |
| cell | μm | proportion % | tap density g/cm³ | kgf/cm | of SiO Vol % | mAh/cm³ | rate % | rate %/cycle |
| 13 | 1 | 5 | 0.56 | — | 30 | 840 | 93 | 1.00 |
| 14 | 1 | 6 | 0.52 | — | 28 | 764 | 98 | 0.10 |
| 15 | 1 | 10 | 0.47 | — | 25 | 658 | 98 | 0.06 |
| 2 | 1 | 15 | 0.42 | — | 22 | 567 | 98 | 0.06 |
| 16 | 1 | 20 | 0.35 | — | 18 | 455 | 98 | 0.06 |
| 17 | 1 | 30 | 0.31 | — | 14 | 372 | 95 | 0.06 |
| 18 | 1 | 35 | 0.28 | — | 12 | 322 | 94 | 0.06 |

As shown in Table 2, it is considered that in test cell 13, the weight proportion of CNFs 12 is too small to form a well-developed conductive network, and this makes the cycle characteristics low. In contrast, in test cells 16 to 18, the amount of CNFs 12 is so large that the volume proportion occupied by cores 11 in mixture layer 1B is less than 19%, making the discharge capacity density small. Thus, when SiO particles having an average particle diameter of 1 μm are used as a source material, the weight proportion of CNFs 12 in the composite negative electrode active material particles is preferably 6% or more and 15% or less.

The following is a description of the case of using, as a source material, SiO particles having an average particle diameter of 8 μm with reference to Table 3 blew. Test cells 19 to 24 are prepared in the same manner as test cell 5 except that the weight proportions of CNFs 12 in the composite negative electrode active material particles are set to 5%, 6%, 10%, 20%, 30%, and 35%, respectively.

TABLE 3

| | | | | Negative electrode | | | High- | |
|---|---|---|---|---|---|---|---|---|
| | | | | | | Discharge | load | |
| | SiO | CNF | Composite negative | Rolling | volume | capacity | capacity | Cycle |
| Test | diameter | weight | electrode material | load | Proportion | density | retention | degradation |
| cell | μm | proportion % | tap density g/cm³ | kgf/cm | of SiO Vol % | mAh/cm³ | rate % | rate %/cycle |
| 19 | 8 | 5 | 0.80 | — | 40 | 1200 | 93 | 1.00 |
| 20 | 8 | 6 | 0.75 | — | 38 | 1103 | 98 | 0.10 |
| 21 | 8 | 10 | 0.67 | — | 33 | 938 | 98 | 0.08 |
| 5 | 8 | 15 | 0.60 | — | 28 | 810 | 98 | 0.06 |
| 22 | 8 | 20 | 0.55 | — | 25 | 715 | 97 | 0.06 |
| 23 | 8 | 30 | 0.45 | — | 19 | 540 | 97 | 0.06 |
| 24 | 8 | 35 | 0.33 | — | 14 | 380 | 97 | 0.06 |

As shown in Table 3, it is considered that in test cell 19, the weight proportion of CNFs 12 is too small to form a well-developed conductive network, and this makes the cycle characteristics low. In contrast, in test cell 24, the amount of CNFs 12 is so large that the volume proportion occupied by cores 11 in mixture layer 1B is less than 19%, making the discharge capacity density small. Thus, when SiO particles having an average particle diameter of 8 μm are used as a source material, the weight proportion of CNFs 12 in the composite negative electrode active material particles is preferably 6% or more and 30% or less.

The following is a description of the case of using, as a source material, SiO particles having an average particle diameter of 14 μm with reference to Table 4 blew. Test cells 25 to 31 are prepared in the same manner as test cell 8 except that the weight proportions of CNFs 12 in the composite negative electrode active material particles are set to 5%, 6%, 10%, 20%, 30%, 35%, and 40% respectively.

TABLE 4

| | | | | Negative electrode | | | High- | |
|---|---|---|---|---|---|---|---|---|
| | | | | | | Discharge | load | |
| | SiO | CNF | Composite negative | Rolling | volume | capacity | capacity | Cycle |
| Test | diameter | weight | electrode material | load | Proportion | density | retention | degradation |
| cell | μm | proportion % | tap density g/cm³ | kgf/cm | of SiO Vol % | mAh/cm³ | rate % | rate %/cycle |
| 25 | 14 | 5 | 0.97 | — | 48 | 1455 | 87 | 1.00 |
| 26 | 14 | 6 | 0.91 | — | 44 | 1338 | 92 | 0.10 |
| 27 | 14 | 10 | 0.82 | — | 39 | 1148 | 92 | 0.08 |
| 8 | 14 | 15 | 0.73 | — | 33 | 986 | 91 | 0.06 |
| 28 | 14 | 20 | 0.67 | — | 29 | 871 | 91 | 0.06 |
| 29 | 14 | 30 | 0.55 | — | 22 | 660 | 91 | 0.06 |
| 30 | 14 | 35 | 0.49 | — | 19 | 564 | 91 | 0.06 |
| 31 | 14 | 40 | 0.43 | — | 16 | 470 | 91 | 0.06 |

As shown in Table 4, it is considered that in test cell 25, the weight proportion of CNFs 12 is too small to form a well-developed conductive network, and this makes the cycle characteristics low. In contrast, in test cell 31, the amount of CNFs 12 is so large that the volume proportion occupied by cores 11 in mixture layer 1B is less than 19%, making the discharge capacity density small. Thus, when SiO particles having an average particle diameter of 14 μm are used as a source material, the weight proportion of CNFs 12 in the composite negative electrode active material particles is preferably 6% or more and 35% or less.

In conclusion, the weight proportion of CNFs 12 to the composite negative electrode active material particles is preferably 6% or more and 35% or less although it is also affected by the average particle diameter of the SiO particles. In terms of cycle characteristics, the weight proportion is more preferably 10% or more. In order to achieve excellent properties regardless of the average particle diameter of the SiO particles, the weight proportion is preferably 6% or more and 15% or less, and more preferably 10% or more and 15% or less. The results of test cells 23, 24, 25 and 26 and test cells 10 to 12 indicate that the volume proportion occupied by cores 11 is preferably 19% or more and 44% or less.

In order to achieve an appropriate volume proportion occupied by the SiO particles without rolling the negative electrode, the tap density of the composite negative electrode active material particles is preferably 0. 42 g/cm³ or more and 0.91 g/cm³ or less based on the results of test cells 2, 16, 23, 24, 25, and 26.

The results of the experiments using the test cell shown in FIGS. 1A and 1B are described hereinbefore. Instead of counter electrode 2 made of metallic lithium, a positive electrode having a mixture layer containing the following positive electrode active material can be used to compose a laminate-type non-aqueous electrolyte secondary battery. Examples of the positive electrode active material include lithium-containing complex oxides such as LiCoO₂, LiNiO₂, Li₂MnO₄, and a mixture or composite thereof. Such a positive electrode active material reduces lithium ions at least during discharge, and contains lithium ions in an uncharged state. In a case where negative electrode 1 does not contain lithium in an uncharged state, the positive electrode need to contain lithium ions as in the present case. Negative electrode 1 having the configuration as described above can be used in a non-aqueous electrolyte secondary battery having this structure so as to achieve a battery excellent in high-load characteristics as well as cycle characteristics.

Besides the aforementioned solution, electrolyte 5 may be made of other various electrolyte solutions containing an organic solvent and a solute dissolved in the solvent. Electrolyte 5 may also be a so-called polymer electrolyte layer containing such an electrolyte solution immobilized in a polymer. In the case of using an electrolyte solution, it is preferable to provide a separator impregnated with the electrolyte solution between counter electrode 2 and negative electrode 1. The separator can be nonwoven fabric or microporous membrane made of polyethylene, polypropylene, an aramid resin, amideimide, polyphenylene sulfide, or polyimide. The separator may also contain a heat resistant filler such as alumina, magnesia, silica, or titania either inside or on its surface. Besides the separator, can be used a heat resistant layer made of one of the fillers and the same binder as used in the negative electrode.

The material of electrolyte 5 is selected based on the oxidation-reduction potential of the active material and other conditions. As the solute for electrolyte 5, salts commonly used in lithium batteries can be used. Examples of the salt include LiPF₆, LiBF₄, LiClO₄, LiAlCl₄, LiSbF₆, LiSCN, LiCF₃SO₃, LiN(CF₃SO₂), LiN(C₂F₅SO₂)₂, LiAsF₆, LiB₁₀Cl₁₀, lower aliphatic lithium carboxylate, LiF, LiCl, LiBr, LiI, chloroborane lithium; various borates such as bis(1,2-benzenediolate(2-)-O,O′)lithium borate, bis(2,3-naphthalenediolate(2-)-O,O′)lithium borate, bis(2,2′-biphenyldiolate(2-)-O,O′)lithium borate, bis(5-fluoro-2-olate-1-benzenesulfonic acid-O,O′)lithium borate; and tetraphenyl lithium borate.

As the organic solvent in which the aforementioned salts are dissolved, solvents commonly used in lithium batteries can be used. Examples of the organic solvent include the following which can be used either on their own or in combination: ethylene carbonate, propylene carbonate, butylene carbonate, vinylene carbonate, dimethyl carbonate, diethyl carbonate, ethyl methyl carbonate, dipropyl carbonate, methyl formate, methyl acetate, methyl propionate, ethyl propionate, dimethoxymethane, γ-butyrolactone, γ-valerolactone, 1,2-diethoxyethane, 1,2-dimethoxyethane, ethoxymethoxyethane, trimethoxymethane, tetrahydrofuran derivatives such as tetrahydrofuran and 2-methyl-tetrahydrofuran, dimethyl sulfoxide, dioxolane derivatives such as 1,3-dioxolane and 4-methyl-1,3-dioxolane, formamide, acetamide, dimethylformamide, acetonitrile, propylnitrile, nitromethane, ethylmonoglyme, trimester phosphate, acetate ester, propionate ester, sulfolane, 3-methyl-sulfolane, 1,3-dimethyl-2-imidazolidinone, 3-methyl-2-oxazolidinone, a propylene carbonate derivative, ethyl ether, diethyl ether, 1,3-propane sultone, anisole, and fluorobenzene.

Electrolyte 5 may further contain an additive such as vinylene carbonate, cyclohexylbenzene, biphenyl, diphenyl ether, vinylethylene carbonate, divinylethylene carbonate, phenylethylene carbonate, diallyl carbonate, fluoroethylene carbonate, catechol carbonate, vinyl acetate, ethylene sulfite, propane sultone, trifluoropropylene carbonate, dibenzofuran, 2,4-difluoroanisole, o-terphenyl, and m-terphenyl.

Electrolyte 5 may alternatively be used in the form of a solid electrolyte by adding the aforementioned solute to the following polymeric materials either on their own or in combination: poly(ethylene oxide), poly(propylene oxide), polyphosphazene, polyaziridine, polyethylene sulfide, polyvinyl alcohol, polyvinylidene fluoride, and polyhexafluoropropylene.

Electrolyte 5 having the polymeric materials may alternatively be used in the form of gel by being mixed with one of the aforementioned organic solvents. As the solid electrolyte can be used an inorganic material such as a lithium nitride, a lithium halide, lithium oxoate, Li₄SiO₄, Li₄SiO₄-LiI-LiOH, Li₃PO₄-Li₄SiO₄, Li₂SiS₃, Li₃PO₄-Li₂S—SiS₂, and a phosphorus sulfide compound.

Specific examples of the positive electrode active material other than the lithium-containing complex oxides mentioned above include olivine-type lithium phosphate expressed by a general formula: LiMPO₄, where M=V, Fe, Ni, or Mn, and lithium fluorophosphates expressed by a general formula: Li₂MPO₄F, where M=V, Fe, Ni, or Mn. It is also possible to replace part of the constituent elements of these lithium-containing compounds by a different element. The surfaces of lithium-containing compounds may be treated with a metal oxide, a lithium oxide, a conductive agent or the like, or may be subjected to hydrophobic treatment.

Specific examples of the conductive agent to be used for the positive electrode include graphites such as natural graphite and artificial graphite; carbon blacks such as acetylene black, Ketjen black, channel black, furnace black, lamp black, and thermal black; conductive fibers such as carbon fiber and metal fiber; metal powders such as carbon fluoride powder and aluminum powder; conductive whiskers such as zinc oxide and potassium titanate; conductive metal oxides such as titanium oxide; and organic conductive materials such as a phenylene derivative.

The binder for the positive electrode can be the same as for negative electrode 1. Specific examples of the binder include PVDF, polytetrafluoroethylene, polyethylene, polypropylene, an aramid resin, polyamide, polyimide, polyamideimide, polyacrylonitrile, polyacrylic acid, poly(methyl acrylate), poly(ethyl acrylate), polyhexylacrylate, poly(methacrylic acid), poly(methyl methacrylate), poly(ethyl methacrylate), poly(hexyl methacrylate), polyvinyl acetate, polyvinylpyrrolidone, polyether, polyethersulfone, hexafluoropolypropylene, styrene-butadiene rubber, and carboxymethyl cellulose. Further other examples of the binder include copolymers containing at least two of the following: tetrafluoroethylene, hexafluoroethylene, hexafluoropropylene, perfluorbalkylvinylether, vinylidene fluoride, chlorotrifluoroethylene, ethylene, propylene, pentafluoropropylene, fluoromethylvinylether, acrylic acid, and hexadiene. Alternatively, two or more of these elements can be mixed.

The current collector and the lead to be used for the positive electrode can be made of stainless steel, aluminum, titanium, carbon, a conductive resin, or the like, and these materials may be surface-treated with carbon, nickel, titanium or the like.

The structure of the battery is not limited to the Aforementioned structure in which the electrode plates face each other. A coin shaped battery, or either a cylindrical or prismatic battery which is obtained by winding thin and long strips of positive and negative electrodes can also provide the same advantages as the battery having the aforementioned structure. Coin shaped batteries do not always need current collector 1A; mixture layer 1B may be formed directly on the inner surface of a metal case, which is made of iron, nickel-plated iron, or the like and also serves as an external terminal. Furthermore, instead of using a wet process with a mixture paste, the composite negative electrode active material may be mixed with a powdered binder and then pressed.

What is claimed is:

1. A negative electrode for non-aqueous electrolyte secondary batteries, the negative electrode comprising a mixture layer including a composite negative electrode active material containing:
active material cores capable of charging and discharging at least lithium ions;
carbon nanofibers attached to surfaces of the active material cores and formed at least between the active material cores; and
at least one catalyst element selected from the group consisting of Cu, Fe, Co, Ni, Mo, and Mn, the catalyst element promoting growth of the carbon nanofibers.

2. The negative electrode for non-aqueous electrolyte secondary batteries of claim 1, wherein
a volume proportion occupied by the active material cores in the mixture layer is at least 19% and at most 44%; and
a weight proportion of the carbon nanofibers in the composite negative electrode active material is at least 6% and at most 35%.

3. The negative electrode for non-aqueous electrolyte secondary batteries of claim 2, wherein
a tap density of the composite negative electrode active material is at least 0.42 g/cm³ and at most 0.91 g/cm³.

4. The negative electrode for non-aqueous electrolyte secondary batteries of claim 1, wherein
the active material cores are silicon oxide particles expressed by SiOx, where 0.05<x<1.95.

5. The negative electrode for non-aqueous electrolyte secondary batteries of claim 1, wherein
an average particle diameter of the active material cores is at least 1 μm and at most 14 μm.

6. A non-aqueous electrolyte secondary battery comprising:
a negative electrode for non-aqueous electrolyte secondary batteries, the negative electrode having a mixture layer including a composite negative electrode active material containing:
active material cores capable of charging and discharging at least lithium ions,
carbon nanofibers attached to surfaces of the active material cores and formed at least between the active material cores, and
at least one catalyst element selected from the group consisting of Cu, Fe, Co, Ni, Mo, and Mn, the catalyst element promoting growth of the carbon nanofibers;
a positive electrode disposed opposite to the negative electrode; and
a non-aqueous electrolyte interposed between the negative electrode and the positive electrode.

7. A method for producing a negative electrode for non-aqueous electrolyte secondary batteries, the method comprising:
providing at least one catalyst element selected from the group consisting of Cu, Fe, Co, Ni, Mo, and Mn at least in a surface part of active material cores capable of charging and discharging at least lithium ions;
growing carbon nanofibers on surfaces of the active material cores in an atmosphere containing carbon-containing gas and hydrogen gas to form a composite negative electrode active material; and
forming a mixture layer in such a manner that the carbon nanofibers are formed at least between the active material cores.

8. The method for producing a negative electrode for non-aqueous electrolyte secondary batteries of claim 7, wherein
the composite negative electrode active material in which the carbon nanofibers are grown on the surfaces of the active material cores has a tap density of at least 0.42 g/cm³ and at most 0.91 g/cm³.

9. The method for producing a negative electrode for non-aqueous electrolyte secondary batteries of claim 7 further comprising:
sintering the composite negative electrode active material in an inert gas atmosphere.

10. The method for producing a negative electrode for non-aqueous electrolyte secondary batteries of claim 7 further comprising:
crushing the active material cores with the carbon nanofibers attached thereto so as to adjust the tap density to at least 0.42 g/cm³ and at most 0.91 g/cm³.
